(19) United States
(12) Patent Application Publication
(10) Pub. No.: US 2006/0036627 A1
(43) Pub. Date: Feb. 16, 2006

(54) Method and apparatus for a restartable hash in a trie

(76) Inventor: Roger Deran, Santa Cruz, CA (US)

Correspondence Address: GLENN PATENT GROUP, 3475 EDISON WAY, SUITE L, MENLO PARK, CA, 94025, US

(21) Appl. No.: 11/253,774

(22) Filed: Oct. 18, 2005

Related U.S. Application Data
(63) Continuation-in-part of application No. 10/912,872, filed on Aug. 6, 2004.

(51) Int. Cl. G06F 7/00

(52) U.S. Cl. 707/100

(57) ABSTRACT

A PATRICIA trie index is very small. However, the index is quite difficult to navigate with efficiency and is prone to traversal errors. An inventive method and apparatus is discussed for computing key hashes in PATRICIA trie nodes using restartable hash algorithms. The invention herein increases performance and overcomes the limitations of other hashing systems used in PATRICIA tries, thus allowing for long chains of hashes to be composed together. This enables reasoning about key strings that match multiple intervening hash sections.

### CROSS-REFERENCE TO RELATED APPLICATIONS

This application is a continuation-in-part of U.S. patent application Ser. No. 10/912,872, filed on Aug. 6, 2004, and which is incorporated herein in its entirety by this reference thereto.

### BACKGROUND OF THE INVENTION

1. Technical Field

The invention relates generally to index hashing of PATRICIA tries. More specifically, the invention relates to a restartable hashing scheme for PATRICIA tries.

2. Discussion of the Prior Art

The Practical Algorithm To Retrieve Information Coded In Alphanumeric (PATRICIA) is a trie shown by D. R. Morrison in 1968. It is well known in the industry as a compact method for indexing, and it is commonly used in databases, as well as in networking technologies. Basically, in a PATRICIA implementation, trie nodes that have only one child are eliminated. The remaining nodes are labeled with a character position number that indicates the nodes' depth in the uncompressed trie.

FIG. 1 shows an example of such an implementation of a PATRICIA trie for an alphabetical case. The words to be stored are “greenbeans”, “greentea”, “grass”, “corn”, and “cow”. The first three words differ from the last two words in the first letter, i.e. three begin with the letter “g” while the other two begin with the letter “c”, hence, there is a difference at the 1st position. Therefore there is a node at depth “0” separating the “g” words from the “c” words.

Moving on the “g” side, the next time a difference is found is in the third position where two words, “greenbeans” and “greentea” have an “e”, while one word “grass” has an “a”. Therefore, a node at that level indicates a depth level of “2”.

Continuing down the left path reveals that the next time a different letter is found is at the sixth position where one word, “greenbeans” has a “b”, while the other word “greentea” has a “t”. Therefore, there is a node at depth “5”. One problem with this implementation is that keys are no longer uniquely specified by the search path. Hence, the key itself has to be stored in the appropriate leaf. An advantage of this approach is that only k*n pointers are required, where “k” is the size of the alphabet and “n” is the number of pointers. A person skilled in the art would easily note that an alphabet having a k=2 is binary alphabet having only two symbols, possibly “0” and “1”. FIG. 2 shows a sample trie implementation for such an alphabet.

A PATRICIA trie is either a leaf L(k) containing a key k, or a node N(d, l, r) containing a bit offset d≧0 along with a left sub-tree/and a right sub-tree r. This is a recursive description of the nodes of a PATRICIA tree. Leaves descending from a node N(d, l, r) must agree on the first d−1 bits. A description of PATRICIA tries may be found in Bumbulis, and Bowman, A Compact B-Tree, Proceedings of the 2002 ACM SIGMOD international conference on management of data, pages 533-541, which is herein incorporated in its entirety by this reference thereto. A block of pointers may be now prepared using the PATRICIA trie architecture, the block having pointers that allow for efficient retrieval of the data. The number of pointers or fanout of the block, may be calculated, based on several parameters.

In a PATRICIA trie, such as shown in FIG. 3, no hashing is used for any of the nodes and therefore, as noted in the literature, navigation through the trie may be difficult and inefficient, and is further prone to traversal errors. Another prior art solution, suffix hashing, suggests the use of suffix bytes, as shown in FIG. 4. The suffix byte uses the 8-bits immediately preceding any node of the PATRICIA trie. This provides certain indexing advantages over no hashing at all. However, the performance improvement in both complexity and traversal errors is limited. In a typical example the number of traversal errors was reduced by 75%. However, because of the large number of errors without any hashing at all this is still significant.

Yet another solution is the use of value hashing, such as shown in FIG. 5. In value hashing each node receives a hash value that represents the entire chain from the route of the PATRICIA trie. Hence, node 510 receives a hash value 515 representing its path (a full line) from the root node: Node 520 receives a separate hash value 525 representing its path (a dashed line) from the root node: Node 530 receives a hash value 535 representing its path (a dashed and two dots line) from the root node. Each of the hash values 515, 525, and 535 is unique and stands on its own. The hash is significantly more expensive to calculate than the suffix hashing and, moreover, the complexity increases as the node is further down in the PATRICIA trie. However, value hashing allows for a significant drop in traversal errors, potentially down to 0.15% in comparison to the PATRICIA trie with no hashing at all.

In view of the limitations of the prior art, it would be advantageous if there was a solution that provides a hashing scheme that is very fast to calculate. It would be further advantageous if such calculations could take advantage of previous stage hash calculations. It would be even further advantageous if such hashing scheme allowed for the handling of gaps in the search string.

### SUMMARY OF THE INVENTION

A PATRICIA trie index is very small. However, the index is quite difficult to navigate through with efficiency and is prone to traversal errors. An inventive method and apparatus is discussed for computing key hashes in PATRICIA trie nodes using restartable hash algorithms. The invention herein increases performance and overcomes the limitations of other hashing systems used in PATRICIA tries, thus allowing for long chains of hashes to be composed together. This enables reasoning about key strings that match multiple intervening hash sections.

### BRIEF DESCRIPTION OF THE DRAWINGS

FIG. 1 is an exemplary of a PATRICIA trie for an alphabetical case (prior art);

FIG. 2 is an exemplary PATRICIA trie for a numerical case (prior art);

FIG. 3 is an exemplary PATRICIA trie using no index hash (prior art);

FIG. 4 is an exemplary PATRICIA trie using suffix bytes (prior art);

FIG. 5 is an exemplary PATRICIA trie using key hashing (Prior Art);

FIG. 6 is an exemplary PATRICIA trie using restartable hashing;

FIG. 7 is an exemplary PATRICIA trie demonstrating the advantage of restartable hashing;

FIG. 8 is an exemplary performance comparison of the restartable hashing scheme to prior art solutions;

FIGS. 9A and 9B show an exemplary code in Java for a restartable hash function;

FIG. 10 is an exemplary flowchart of the restartable hash function; and

FIG. 11 is an exemplary flowchart for caching hash codes.

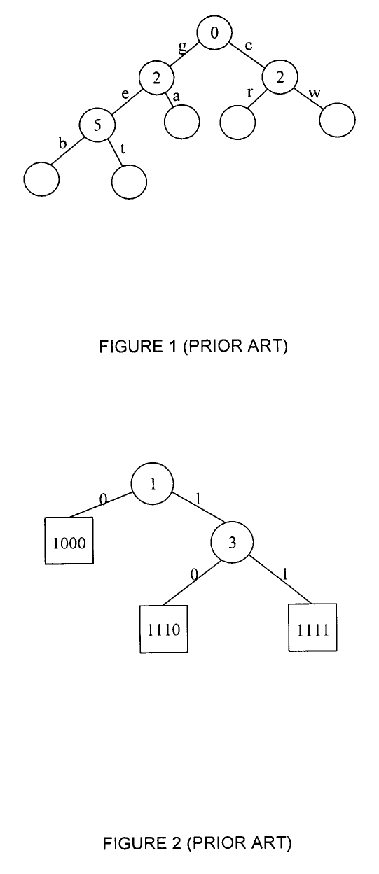

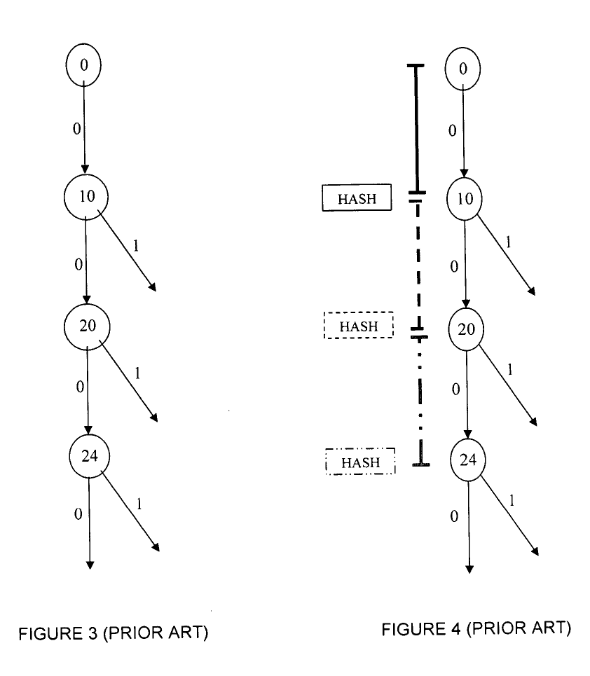

### DETAILED DESCRIPTION OF THE INVENTION

To overcome the limitations of prior art, a hashing scheme is introduced to support the indexing of a PATRICIA trie or other sparse tree indexing keys, especially Layered PATRICIAs, by reducing the frequency of traversal errors. Furthermore, a restartable hashing scheme that allows for the support of gaps, i.e. unknown values, in a search string is introduced. Also, a means for using the restartable hashing to provide for a fast calculation of key hashes is disclosed. A method for hash caching using restartable hashing is also shown. Furthermore, a novel segmented key hashing technique is disclosed. A detailed description of a layered PATRICIA is provided in U.S. patent application Ser. No. 10/912,872, titled A Cascading Index Method and Apparatus, and assigned to common assignee, which is hereby included in its entirety by this reference thereto.

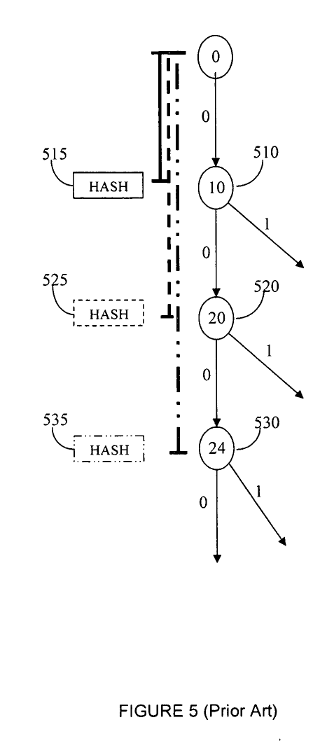

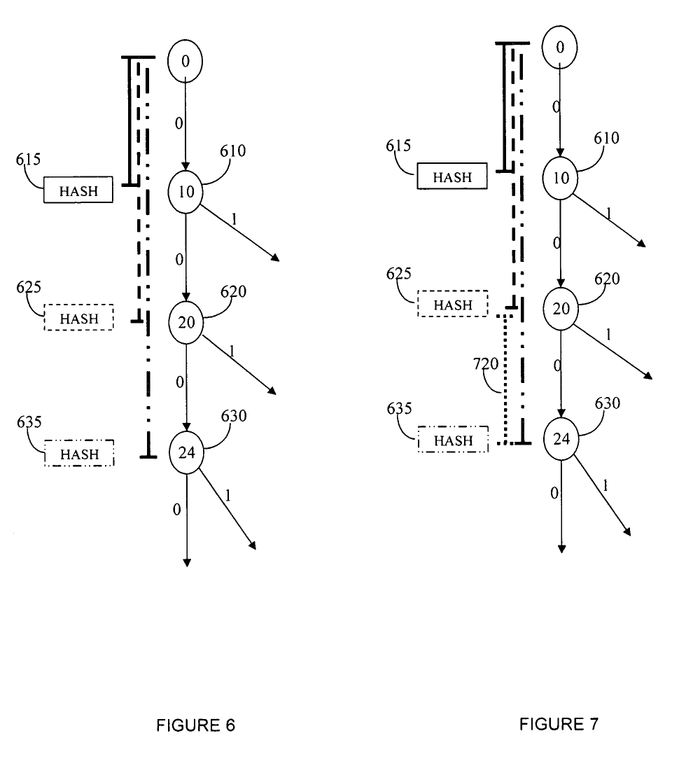

FIG. 6 shows an exemplary and non-limiting PATRICIA trie using a restartable hashing scheme. While the hashing structure, i.e. going back to the nodes' origin, is similar to that shown in FIG. 5, a key difference lies in the actual hashing scheme itself. Specifically, even if the tries of FIG. 5 and FIG. 6 are identical the respective hash value, for example hash value 615, is different from has value 515 and, similarly, hash value 635 is different from hash value 535. However, hash values 615, 625, and 635 correspond to the specific path from the root node to nodes 610, 620, and 630, respectively. A quality of this hashing function is shown in FIG. 7, which demonstrates the capability of creating a hash value 635 at a node 630 by using the hash value 625 together with a hash value 720 calculated between node 620 and node 630. Therefore, it is not necessary to calculate the entire hash from the root node. Hence this embodiment of the invention significantly simplifies the calculation of the hash values of the trie. More specifically, it avoids the need to calculate a hash value from very long index strings. An exemplary but non-limiting hash could be, for example a simple 8-bit or modulo-256 count of the number of ones preceding a node, node 730, or an XOR or sum of the bytes and partial bytes preceding a node. A more detailed discussion of the proposed restartable hashing algorithm is provided below.

In addition to providing a higher speed of calculation of the hash for each node, the invention also provides the ability to predict accurately whether a string matches a search string, even when there are gaps. Considering the following example for a search string:

????????????????????00110

In this case a there are twenty “?” marks that can match anything, for example either “1” or “0”, followed by “00110”. Namely, in this query anything that matches “00110” in positions 20 to 24, with no regard for the first 20 bits (bits 0 to 19), is considered to be a match. Because hashing depends on all the bits used, non-restartable hashing schemes normally render useless answers. By contrast, restartable hashing, disclosed herein, provides usable information. Hence, an advantage of the restartable hashing scheme disclosed herein is that it tests a part of a key string covered in the middle of the hash. This can be done without knowledge of the key string prefix.

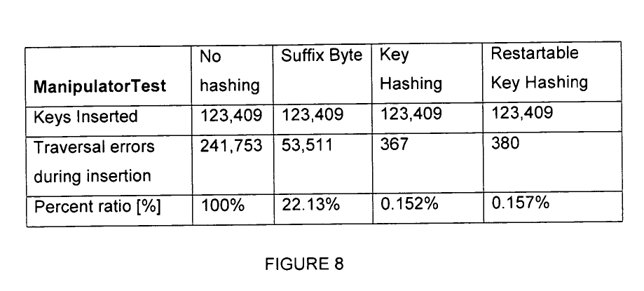

Returning to the example above, one may wish to check whether the string “00110” is the string leading from node 730 to node 740, noted as sequence 732. Using the restartable hashing scheme, the expected hash of node 740 may be calculated by using the value of node 730, the hash of node 730, the value of node 740, and the string “00110”. This generates an expected hash for node 740, which can now be compared to the actual value of hash 735. If the calculated hash matches the hash at 735, then there is a high probability of a match in the index. If the calculated hash does not match the hash at 735 then there is no match. Simulations made by the inventor have shown a significant decrease of traversal errors. Hence, the overall performance of the system is improved. In fact, the performance was simulated to be comparable to that of key hashing but with a significantly reduced hashing computation, as well as providing for the gaps or partial matching search, as shown above. An exemplary and non-limiting performance comparison is shown in FIG. 8.

A person skilled in the art would further note that this property of the restartable hashing function is composable. Therefore, long chains of hashes can be composed together to reason about key strings that match multiple intervening hash sections. This can be described as follows:
Hash(N₆₁₀, H₆₁₅, N₆₃₀)=Hash(N₆₂₀, Hash(N₆,₀,0, N₆₂₀), N₆₃₀) (1)

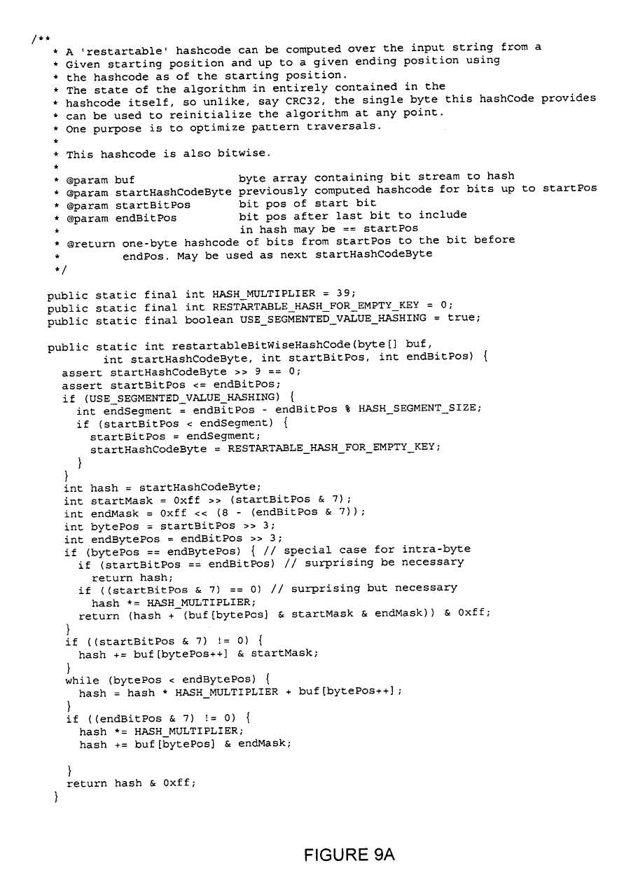

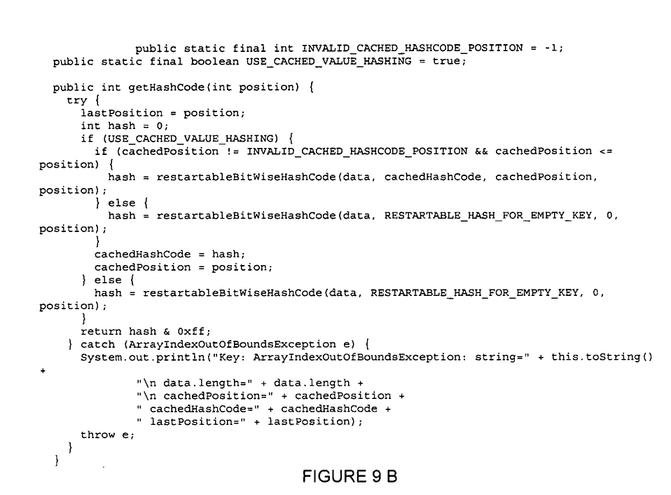

FIG. 9 shows an exemplary and non-limiting restartable hashing in accordance with the disclosed invention. A person skilled in the art could convert this Java language example into any computer language, a firmware, hardware, or combination thereof implementation without departing from the scope of the disclosed invention. To restart the hash, the hash code of a head bit string is plugged back into the algorithm and bits of a tail bit string are pumped into it from that point, getting a hash value back out that is the same value that would have been calculated had the head and tail bits strings been hashed all at once. Hence, a restartable hash disclosed herein has the property that its entire state is contained within the value of the hash code at any point.

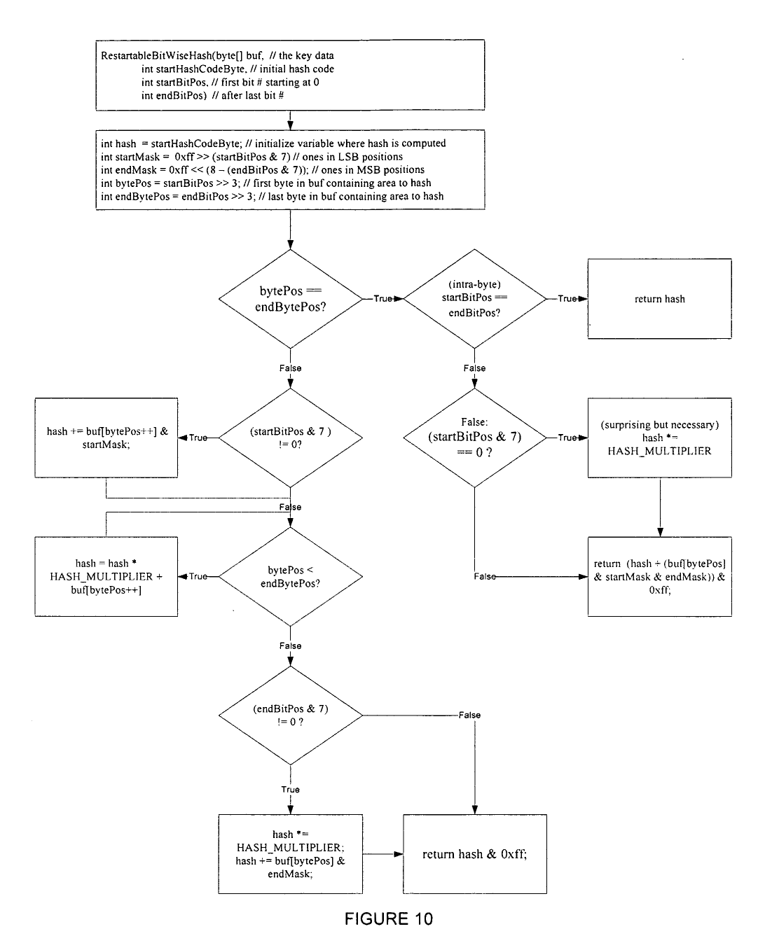

For purpose of clarification and further generality of the disclosed invention, FIG. 10 shows an exemplary and non-limiting flowchart of the restartable hashing. A person skilled in the art would realize that a Java language implementation is shown herein, and that a use of another programming language should not be considered a departure from the disclosure made herein and such programs are within the scope of the current invention.

A restartable hash makes it possible to skip some in-string nodes (and their subtries), i.e. nodes whose positions are within the relative key string. The leftmost in-string node cannot be checked, but the ones to the right (larger position) may be skipped. The algorithm ignores the relative key string bits before the leftmost in-string node, but makes the assumption that these bits match the iteration key. Then, the hash algorithm is restarted using the hash code of this leftmost node, and the bits from the relative string from its position rightwards are pumped in. As the pumping progresses through the relative key string, the hash code can be extracted from the algorithm as nodes are passed, and the extracted hash code can be compared to the hash codes in the passed nodes. If there is a difference between the node hash codes and the algorithm's hash codes, the match returns false. Otherwise, the path may match and “true” is returned.

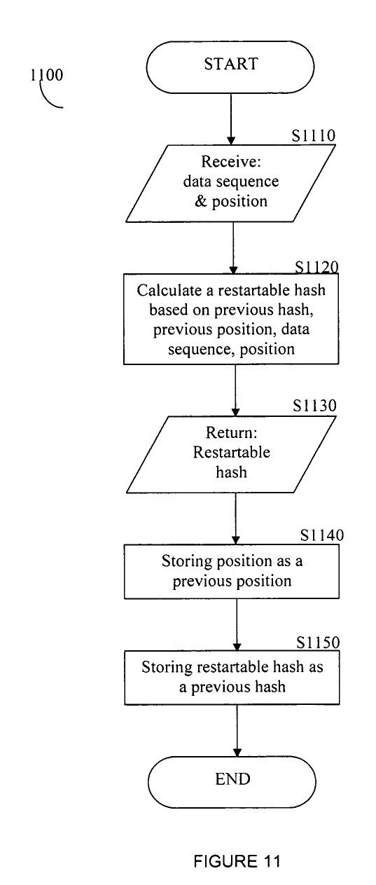

A further novel use for restartability is in caching the key hash codes. Calculation of hashes that have a local pattern of monotonically increasing positions may be reduced. The preferred but non-limiting way to store hash caches is in the key string itself, as shown in an exemplary and non-limiting flowchart 1100 of FIG. 11. A current position and current hash code are maintained. Whenever the current position is larger than the previous, the previous hash code is used to restart the hashing at that position and run it forward to the new position. The new position is then stored with the new hash code as the cached hash and position, the new hash code being returned as the result of the operation as if the caching were not being used. More specifically, in step S1110 there are received a data sequence and a position. In step S1120, a restartable hash is calculated based on the previous hash, the previous position, the received data sequence, and the received position. In step S1130, the restartable hash value calculated in S1120 is returned. In steps S1140 and S1150, the previous position is replaced by the received position, and the previous hash is replaced by the new hash calculated.

The pattern of increasing positions is very common in the search phase of most operations on tries containing key hashes at the nodes, and often the increases in position are very small, so that the reduction of calculation time is correspondingly great. It is common to have to perform another hash operation as each node is examined during the downwards traversal. In the preferred embodiment, in which the trie is binary, trie depths on the order of up to fifty or more nodes are not uncommon. So the increase in calculation speed is very important. When the trie has a small set of possible labels at each node, there are more nodes and the calculation time becomes even more important.

A further novel improvement to a restartable or other hash in the nodes of a trie is segmentation. In this scheme, the key is divided into segments within which the hash code is computed, so that the hash code at any position is dependent only on the data in the key after the end of the nearest earlier segment. A non-limiting example of this method appears in FIGS. 9A and 9B, which show an exemplary and non-limiting Java code. A person skilled in the art would see that dividing the hash code into such segments is applicable not only to restartable hashing but also to hashing used with any type of trie, and the technique can easily be applied using any programming language. Advantages of such an approach includes reduction in the hash computation time and the ability to perform pattern matching on gaps that occur before the beginning of the segment within which the known portion of the key occurs. The exemplary implementation combines restartability with segmentation, but segmentation can be used without restartability.

A person skilled-in-the-art would readily understand that the inventions herein may be integrated as part of a database system, and more specifically a database file management system, for the purpose of taking advantage of the teachings of the disclosed invention. Furthermore, the teachings herein may be implemented in a computer software product containing a plurality of instructions, the instructions when executed resulting in the performance of the teachings herein.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. A trie, comprising:
a plurality of nodes ordered in a PATRICIA structure; and
a hash value associated with a node of said PATRICIA structure, said hash value comprising a restartable hash value.

2. The trie of claim 1, said restartable hash value comprising a value derived from:
a starting hash value, a starting position in said PATRICIA structure; a data sequence from said starting point to said node; and a position of said node within said PATRICIA structure.

3. The trie of claim 1, said plurality of nodes comprising at least one node comprising a key having at least two segments.

4. The trie of claim 1, further comprising:
a pre-computed hash value for enabling the generation of said restartable hash value.

5. The trie of claim 4, said PATRICIA structure comprising one of:
a PATRICIA trie;
a block index incorporating a PATRICIA trie; and
a Layered PATRICIA trie.

6. A memory containing the trie of claim 1.

7. A storage medium in a database file management system having at least a trie, said trie comprising:
a plurality of nodes ordered in a PATRICIA structure; and
a hash value associated with a node of said PATRICIA structure, said hash value comprising a restartable hash value.

8. The storage medium of claim 7, said restartable hash value comprising a value derived from:
a starting hash value; a starting position in said PATRICIA structure; a data sequence from said starting point to said node; and a position of said node within said PATRICIA structure.

9. The storage medium of claim 7, said plurality of nodes comprising at least one node comprising a key having at least two segments.

10. The storage medium of claim 7, further comprising:
a pre-computed hash value for the enabling generation of said restartable hash value.

11. The storage medium of claim 10, said PATRICIA structure comprising one of:
a PATRICIA trie; block index incorporating a PATRICIA tries; and
a Layered PATRICIA trie.

12. A trie indexing system, comprising:
a plurality of nodes ordered in a PATRICIA structure;
means for generating at least one hash value, said hash value comprising a value derived from a key of at least one of said plurality of nodes; and
means for associating said hash value with one of said plurality of nodes.

13. The system of claim 12, wherein said hash value comprises a value derived from:
a starting hash value; a starting position in said PATRICIA structure; a data sequence from said starting point to said node; and a position of said node within said PATRICIA structure.

14. The system of claim 12, wherein said key is divided into two or more segments.

15. A method for calculating a restartable hash, comprising the steps of:
receiving a starting hash, a starting position, a data sequence, and an ending position;
computing a total hash, said total hash being a function of said starting hash and a segment of said data sequence starting at said starting position and ending at said ending position, wherein said total hash is equal to a composed hash obtained by computing a first hash and a second hash, said first hash having inputs of said starting position, said data sequence, and an intermediate position, and resulting in an intermediate hash, said second hash having inputs of said intermediate hash, an intermediate position, said data sequence, and said ending position, the combination of said first hash and said second hash being equal to said total hash; and
returning said total hash.

16. The method of claim 15, further comprising the steps of:
initializing a current value to an initial value;
combining said current value with an element of said data sequence between said starting position and said ending position to produce a new current value;
combining said current value with a second element of said data sequence between said starting position and said ending position to produce a new current value; and
returning said new current value as said total hash.

17. The method of claim 16, wherein said data sequence is a key in an index.

18. A computer software product containing a sequence of instructions for calculating a restartable hash, the sequence of instructions further comprising a method that comprises the steps of:
receiving a starting hash, a starting position, a data sequence, and an ending position;
computing a total hash, said total hash being a function of said starting hash and a segment of said data sequence starting at said starting position and ending at said ending position, wherein said total hash is equal to a composed hash obtained by computing a first hash and a second hash, said first hash having inputs of said starting position, said data sequence, and an intermediate position, and resulting in an intermediate hash, said second hash having inputs of said intermediate hash, an intermediate position, said data sequence, and said ending position, the combination of said first hash and said second hash being equal to said total hash; and
returning said total hash.

19. The computer software product of claim 18, wherein said method further comprises the steps of:
initializing a current value to an initial value;
combining said current value with an element of said data sequence between said starting position and said ending position to produce a new current value;
combining said current value with a second element of said data sequence between said starting position and said ending position to produce a new current value; and
returning said new current value as said total hash.

20. The computer software product of claim 19, wherein said data sequence is a key in an index.

21. A method for caching hash codes, comprising the steps of:
receiving a data sequence and a position;
calculating a restartable hash based on at least a stored previous hash, a stored previous position, said data sequence, and said position;
storing said position as said previous position;
storing said restartable hash as said previous hash; and
returning said hash as a result.

22. A memory containing a hash code that was generated by the method of claim 21.

23. A memory containing a plurality of nodes organized as a PATRICIA structure, at least one node having an associated hash code, the hash code being generated by the method of claim 21.

24. A computer software product containing a sequence of instructions for caching hash codes, the sequence of instructions further comprising a method that comprises the steps of:
receiving a data sequence and a position;
calculating a restartable hash based on at least a stored previous hash, a stored previous position, said data sequence, and said position;
storing said position as said previous position;
storing said restartable hash as said previous hash; and
returning said hash as a result.

25. A method for computing a hash code for a key in a trie at a given position, comprising the steps of:
receiving a data sequence and a position;
computing a hash code of said data sequence starting at a fixed position and ending at said position; and
returning said computed hash code.

26. The method of claim 25, wherein said trie comprises one of:
a PATRICIA; a layered PATRICIA; and a block-index trie.

27. A memory containing a hash code for a key that was generated by the method of claim 25.

28. A memory containing a plurality of nodes organized as a PATRICIA structure, at least one node having an associated hash code for a key, the hash code for the key being generated by the method of claim 25.

29. A computer software product containing a sequence of instructions for computing a hash code for a key in a trie at a given position, the sequence of instructions further comprising a method that comprises the steps of:
receiving a data sequence and a position;
computing a hash code of said data sequence starting at a fixed position and ending at said position; and
returning said computed hash code.

30. The computer software product of claim 29, wherein said trie comprises one of:
a PATRICIA, layered PATRICIA; and a block-index trie.

31. A method for computing a hash code for a key in a trie, comprising the steps of:
dividing said key into segments within to which said hash code is computed;
wherein said hash code at any position is dependent only on data within said key after an end of a nearest earlier segment.
